(19) United States
(12) Patent Application Publication
(10) Pub. No.: US 2002/0059310 A1
(43) Pub. Date: May 16, 2002

(54) System and method for real-time device driver error handling

(76) Inventor: In-Sung Choi, Seoul (KR)

Correspondence Address: Robert E. Bushnell, Suite 300, 1522 K Street, N.W., Washington, DC, 20005, US

(21) Appl. No.: 09/898,088

(22) Filed: Jul. 5, 2001

(30) Foreign Application Priority Data
Aug. 17, 2000 (KR) 2000-47588

(51) Int. Cl. G06F 12/00

(52) U.S. Cl. 707/200

(57) ABSTRACT

The present invention discloses a system for real-time device driver error handling. The system includes a user computer having a device driver, a monitoring unit and a device drive information, the monitoring unit monitoring an operating state and searching the device driver information, and outputting the diagnosing message to the user when the device driver errors occur, a web server having a driver error handling program, the device drive error handling program storing a standard driver information, performing a diagnosis of the device driver by comparing the standard driver information with the device driver information, and displaying the diagnosing result on the user computer.

This application makes reference to, incorporates the same herein, and claims all benefits accruing under 35 U.S.C. §119 from an application entitled System and Method for Real-time Device Driver Error Handling earlier filed in the Korean Industrial Property Office on Aug. 17, 2000, and there duly assigned Ser. No. 2000-47588 by that Office.

### BACKGROUND OF THE INVENTION

1. Field of the Invention

The present invention relates to a system and a method for device driver error handling, and more particularly to a system and method for automatic real-time device driver error handling.

2. Description of the Background Art

In general, when users try to drive a certain device such as a printer through a personal computer, users have to first install a driver that is a driving program of the device in the personal computer. In order to install a driver in the computer, a system-related file information and a registry information should be changed or newly registered to make the device driver compatible with a system circumstance of the computer. However, general users cannot know all the details of system-related file information and the registry information thoroughly, and thus driver manufacturers generally provide users with a package driver for automatically installing the device driver.

Such a device driver may cause errors due to system characteristics (e.g., central processing unit performance, disk unit performance, etc.) and the characteristics of other applications. However, most users cannot correct the errors. In order to overcome the problem, the users have to contact a service center or a web server that provides information related to the device driver. In case of the former, if the user receives a visit from a worker of the service center, a long time is required for correcting the error. In case of the later, the web server just provides a general solution and thus the user has to correct errors by himself or herself with reference to the general solution. Therefore, it is very difficult for the user who does not have much experience with device drivers to understands the content and the terms of the solution to correct the errors. For example, if an erroneous information is stored in the registry, it is very difficult that the user understands the situation and corrects the error. In other words, since the web server provides a general solution to the error, it is very difficult to accurately correct the registry information.

When a device driver error occurs, the user contacts the web server that has a checking program in order to correct the error. The user downloads the checking program from the web server into his computer. Then, the user installs the checking program in the computer and executes it. At this time, the checking program checks the device driver error and provides a solution to the error. The user identifies the solution, and then deletes the checking program. The user corrects the device driver error by using the solution that the checking program provides.

The method described above has a disadvantage of the user having to download the checking program from the web server into the computer, and after solving the error, the checking program has to be deleted in consideration of the storage capacity of the computer. In order to overcome the problem of storage capacity, the checking program may be provided through an auxiliary storage device such as a floppy diskette or a compact disc (CD). However, when the device is upgraded, the checking program contained in the auxiliary storage device may not be compatible with the device. The checking problem may also have difficulties in being uninstalled from the personal computer. In addition, since the checking program provides only directions on how the error may be corrected, it is not that easy for the user to correct the error using the solution directions by himself or herself. Therefore, a reliability of the product may be lowered, and an economic load of the user may increase.

Exemplars of the art are U.S. Pat. No. 6,049,798 issued to Bishop et al for Real Time Internal Resource Monitor for Data Processing System, U.S. Pat. No. 5,630,076 issued to Saulpaugh et al. for Dynamic Device Matching Using Driver Candidate Lists, U.S. Pat. No. 5,339,432 issued to Crick for Method and System for Providing User Control of Device Driver Configuration, U.S. Pat. No. 4,979,107 issued to Advani et al for Modification of Device Configuration Wherein the System Specified and Prompts the User with Only Parameters Requested to Be Changed, U.S. Pat. No. 5,815,731 issued to Doyle et al. for Method and System for Providing Device Driver Configurations on Demand, and WO Patent No. 00/26805 issued to Maxwell et al for Method and Apparatus for New Device Driver Installation by an Operating System.

For the foregoing reasons, there is a need for a system that can correct device driver errors automatically.

### SUMMARY OF THE INVENTION

It is therefore an object of the present invention to provide a system for real-time device driver error handling that can correct device driver errors automatically.

It is another object to have a system and method that can efficiently and without much user intervention, correct device driver problems in computers.

It is yet another object to have a highly accurate device driver error handling.

It is still yet another object to have the most recent information available in correcting device driver problems.

In order to achieve the above objects, the preferred embodiment of the present invention provides a system for real-time device driver error handling. The system includes a user computer having a device driver, a monitoring unit and a device drive information, the monitoring unit monitoring an operating state and searching the device driver information, and outputting the diagnosing message to the user when the device driver errors occur, an internet web server having a driver error handling program, the device drive error handling program storing a standard driver information, performing a diagnosis of the device driver by comparing the standard driver information with the device driver information, and displaying the diagnosing result on the user computer.

The web server includes a standard driver information storing portion of storing the standard driver information, a diagnosis driver information interpreting portion for interpreting the device driver information searched by the monitoring portion, a diagnosis portion for performing a diagnosis of the device driver by comparing the standard driver information with the device driver information, and a diagnosing result handling portion for displaying the diagnosing result to the user computer. The diagnosing result handling portion displays the error correction result to the user computer after auto-correcting the error by the stored standard diagnosis information in case of auto-correctable error, displays how to correct the error to the computer user in case of auto-uncorrectable error, when the device driver error occurs.

The preferred embodiment of the present invention further provides a method of real-time device driver error handling. The method includes installing a monitoring unit in order to monitor the state of a user computer and an operating state of a device driver in the user computer, storing a standard diagnosis information of the device driver in order to perform a diagnosis, monitoring an operating state of the device driver to detect device driver errors through the monitoring file, contacting the user computer with the web server to execute the driver error handling program through a network, thereby performing a diagnosis of the device driver, confirming the device driver errors by comparing the standard driver information with the device driver information of the device driver, and displaying a diagnosing result to the user computer.

The method further includes discriminating whether the device driver error is automatically correctable or uncorrectable, correcting the error when the user computer accepts a correction message in case of the automatically correctable error, thereafter displaying a error correction result, and displaying how to correct the device driver errors in case of the automatically uncorrectable error. The method further includes outputting a message of an automatic correction advice to the user computer when the user computer does not accept correction message in case of the automatically correctable error. The step of installing a monitoring unit is to simultaneously install the monitoring unit for the device driver when a device driver is installed in the user computer.

Using the system for real-time device driver error handling, even those who are not skilled in device drivers can correct the device driver error accurately. Further, the device driver error correction is simple as compared with earlier methods. Furthermore, it is easy to maintain the device, leading to a high reliability of the product.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a flow chart illustrating a method of handling a device driver error according to earlier art;

FIG. 2 is a block diagram illustrating a system for device driver error handling according to the preferred embodiment of the present invention;

FIGS. 3A and 3B are flow charts illustrating a method of device driver error handling according to the preferred embodiment of the present invention; and

FIGS. 4A to 4I show a process of installing various device drivers in the user computer.

### DETAILED DESCRIPTION OF THE PREFERRED EMBODIMENTS

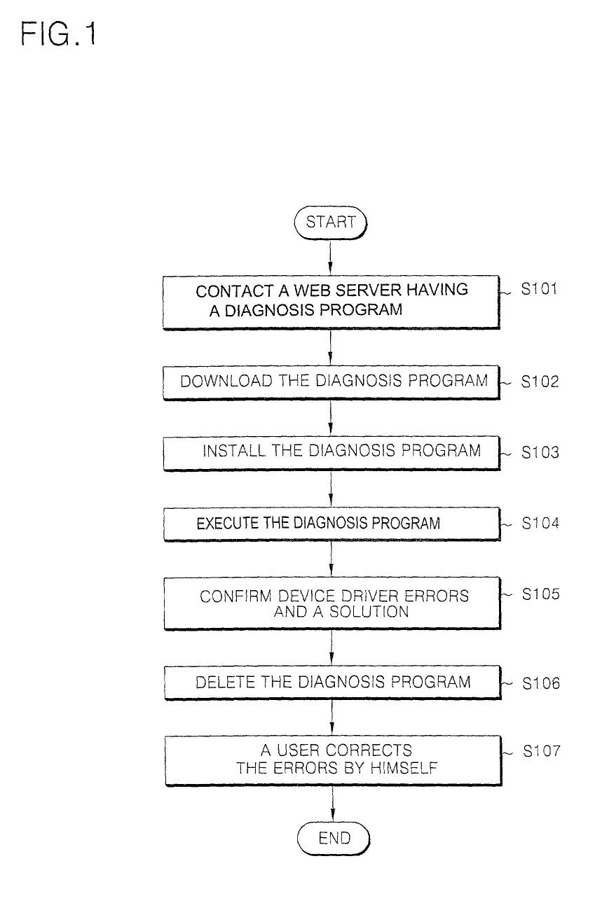

Turning now to the drawings, FIG. 1 is a flow chart illustrating a method of handling a device driver error according to a conventional art. As shown in FIG. 1, when a device driver error occurs, the user contacts the web server having a checking program in order to correct the error (step S101). The user downloads the checking program from the web server into his computer (step S102). Then, the user installs the checking program in the computer (step S103) and executes it (step S104). At this time, the checking program checks the device driver error and provides a solution to the error. The user identifies the solution (step S105), and then deletes the checking program (step S106). The user corrects the device driver error by himself using the solution that the checking program provides (step S107).

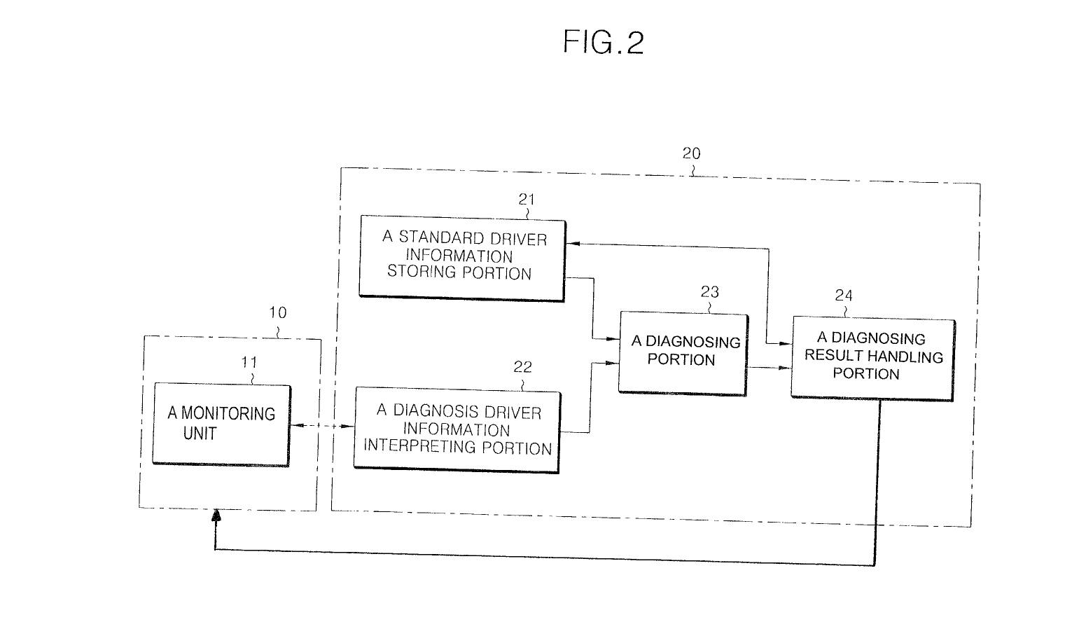

FIG. 2 is a block diagram illustrating a system for device driver error handling according to the preferred embodiment of the present invention. As shown in FIG. 2, the system for device driver error handling has a user computer 10 and a web server 20. The user computer 10 contacts the web server 20 through a network, for example, an Internet, for device driver error handling. The user computer 10 has a device driver (not shown) and a monitoring unit 11. The monitoring unit 11 serves to monitor a state of the device driver. For example, a driver file state, a registry information, a profile information, a port state, a driver installation, and the like are monitored by the monitoring unit 11 to output an error message. The monitoring unit 11 is constructed in the form of a monitoring file such as “monitoring.dll”, so that the user does not manipulate nor change it as he or she pleases. “Monitoring.dll” is a file used in an example operating system of “WINDOWS” of the MICROSOFT Corporation. The monitoring file “monitoring.dll” is stored in a directory “WINDOWS” or a directory in which the device drivers are installed. The monitoring file “monitoring.dll” is stored at the same time when the device driver is installed. The monitoring unit can be installed in an another way in the case of not installing the monitoring file when the device driver is installed.

The web server 20 has a driver error handling program. The driver error handling program includes a standard driver information storing portion 21, a diagnosis driver information interpreting portion 22, a diagnosing portion 23, and a diagnosing result handling portion 24. The standard driver information storing portion 21 stores a standard driver information of various device drivers. The standard driver information of various device drivers is renewed by an operator of the web server 20 as the device is upgraded. The standard driver information may contain parameters of the device driver that allows the device corresponding to the device driver to function normally. The diagnosis driver information interpreting portion 22 interprets an information of the device driver when it receives a request for the device driver diagnosis from the monitoring unit 1. The diagnosing portion 23 compares the standard driver information stored in the standard driver information storing portion 21 with the diagnosis driver information interpreted to diagnose an operating state of the device driver. The diagnosing result handling portion 24 displays a diagnosis result on the user computer 10. The user computer 10 includes a display device (not shown) to display the diagnosis result. When an error occurs in the device driver, the diagnosing result handling portion 24 discriminates whether the error can be correctable or not in order to perform follow-up measures. In other words, if the device driver error is correctable, the diagnosing result handling portion 24 displays an error correction message on the user computer, corrects the device driver error using the standard driver information stored in the standard driver information storing portion 21, and displays the error correction result on the user computer 10, when the user computer accepts an error correction message. If the user computer does not accept the error correction message, the diagnosing result handling portion 24 displays a message of automatic correction advice on the user computer. On the contrary, if the error is uncorrectable, the diagnosing result handling portion 24 displays how to correct the error on the user computer 10. At this point, the correctable error is a software error such as a mistaken setting of the registry information, and the uncorrectable error is a hardware error such as an unstable connection between the device and the computer.

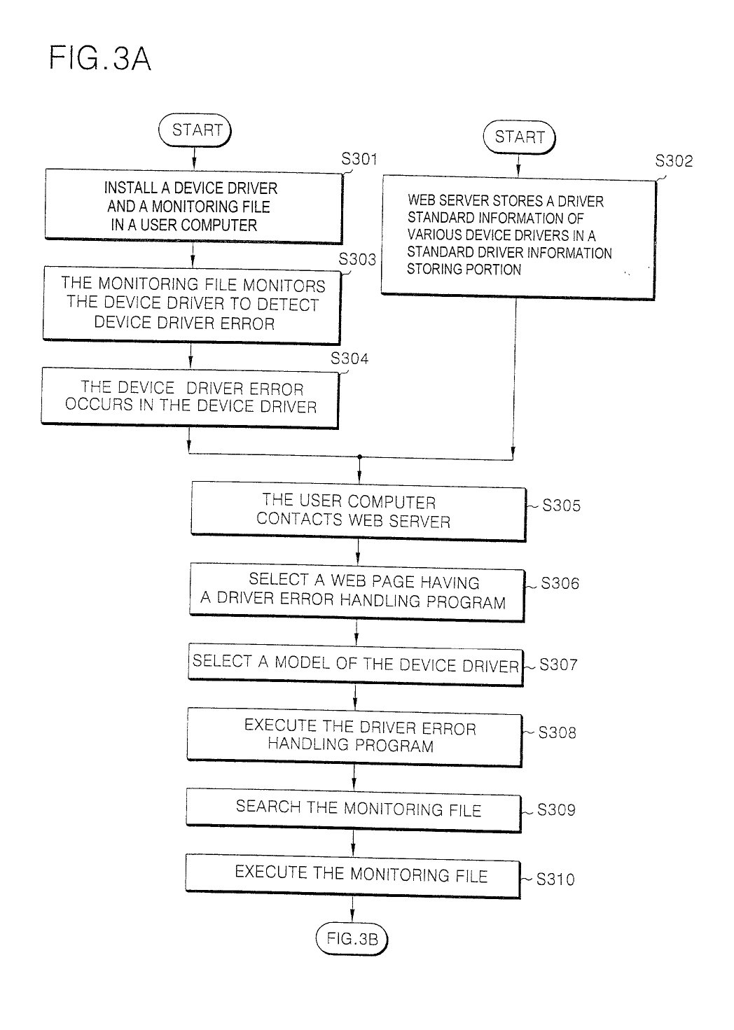

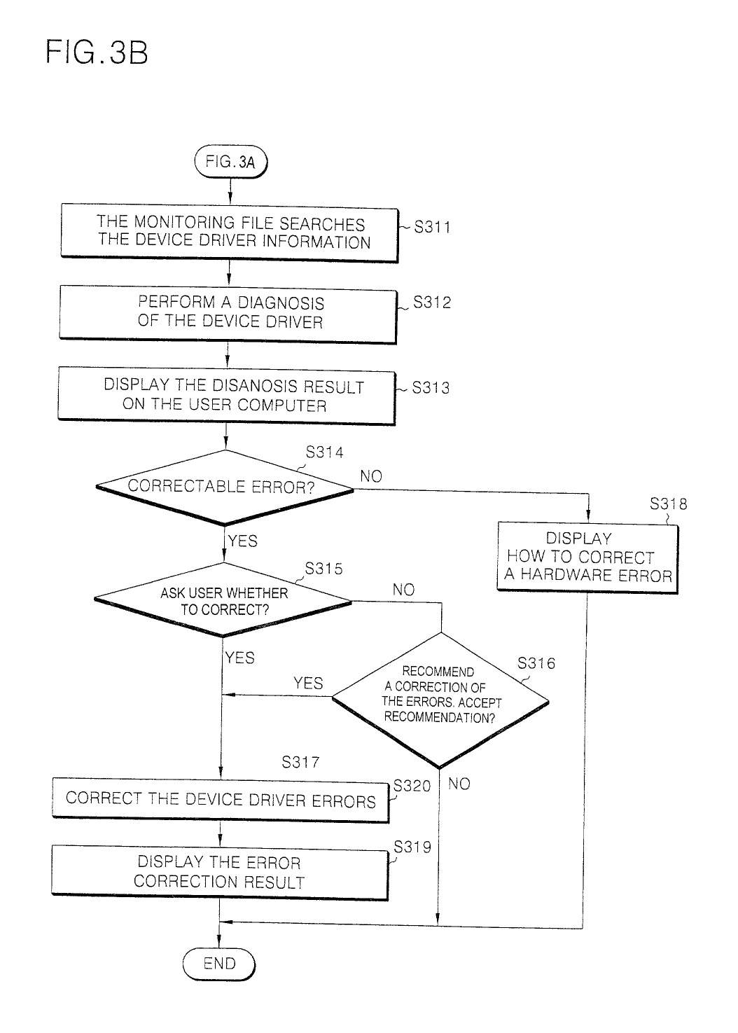

FIGS. 3A and 3B are flow charts illustrating a method of device driver error handling according to the preferred embodiment of the present invention. First, a device driver is installed in the user computer 10. At the same time, the monitoring file is installed in the user computer 10 (step S301). However, the monitoring file may be installed independent of the device driver. Also, the web server stores a driver standard information of various device drivers (step S302). The installed monitoring file monitors the device driver (step S303). At this time, when device driver errors occur (step S304), the user contacts a home page of the web server 20 (step S305) and selects a web page having the driver error handling program (step S306). The user selects a model of the device driver installed in the user computer 10 (step S307) and executes the driver error handling program (step S308). The driver error handling program searches the monitoring file installed in the user computer 10 (step S309). Subsequently, the driver error handling program executes the monitoring file (step S310), so that the monitoring file searches the device driver information (step S311). The diagnosis driver information interpreting portion 22 interprets the device driver information searched by the monitoring file. The diagnosis portion 23 compares the standard driver information stored in the standard driver information storing portion 21 with the diagnosis driver information interpreted by the diagnosis driver information interpreting portion 22 (step S312). The diagnosis result is displayed on the user computer 10 (step S313). The diagnosing result handling portion 24 discriminates whether the device errors are correctable or not (step S314). At this time, if the device driver errors are correctable, the web server displays a correction message inquiring as to whether the user wants to correct the error or not (step S315). Thereafter if the user does not accept the correction message (does not agree to correct the errors), the web server recommends a correction of the errors (step S316). When the user accepts a recommendation or the correction message, the diagnosing result handling portion 24 corrects the device driver errors (step S317). On the contrary, if the device driver errors are uncorrectable, the diagnosing result handling portion 24 only displays instruction as to how to handle the errors such as hardware errors on the user computer 10 (step

In more detail, an example of corrections of device drivers is if part of the driver file is deleted, the driver error handling program restores the deleted part of the driver file. Also, if the registry information is incorrect in the settings or is deleted, the driver error handling program restores the registry information. If a folder and an icon are not produced, the driver error handling program produces the folder and the icon. If there is a mistake in the profile information, the driver error handling program restores the profile information. That is, the driver error handling program corrects a variety of the device driver errors to operate the device normally. Finally, after the error correction, the driver error handling program displays the error correction result on the user computer 10 (step S319).

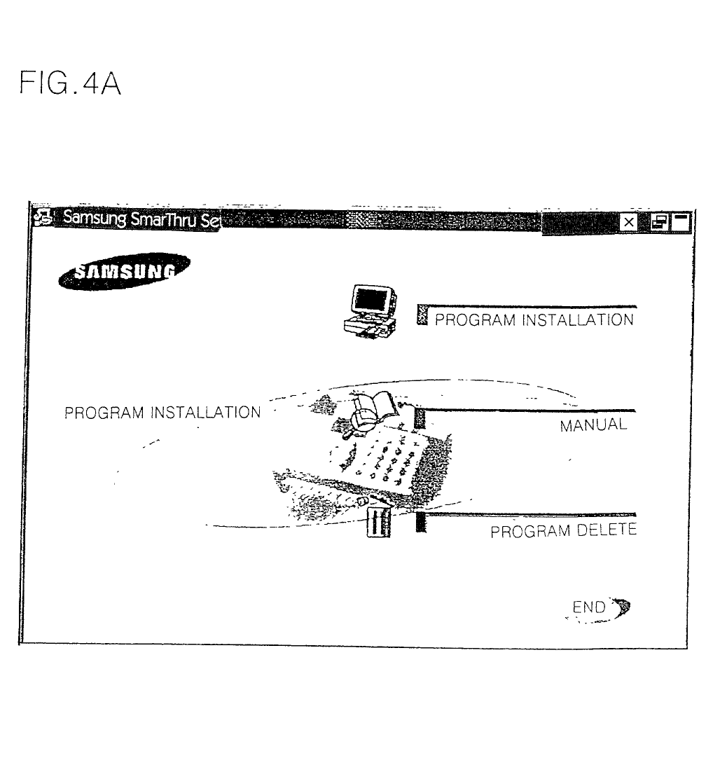

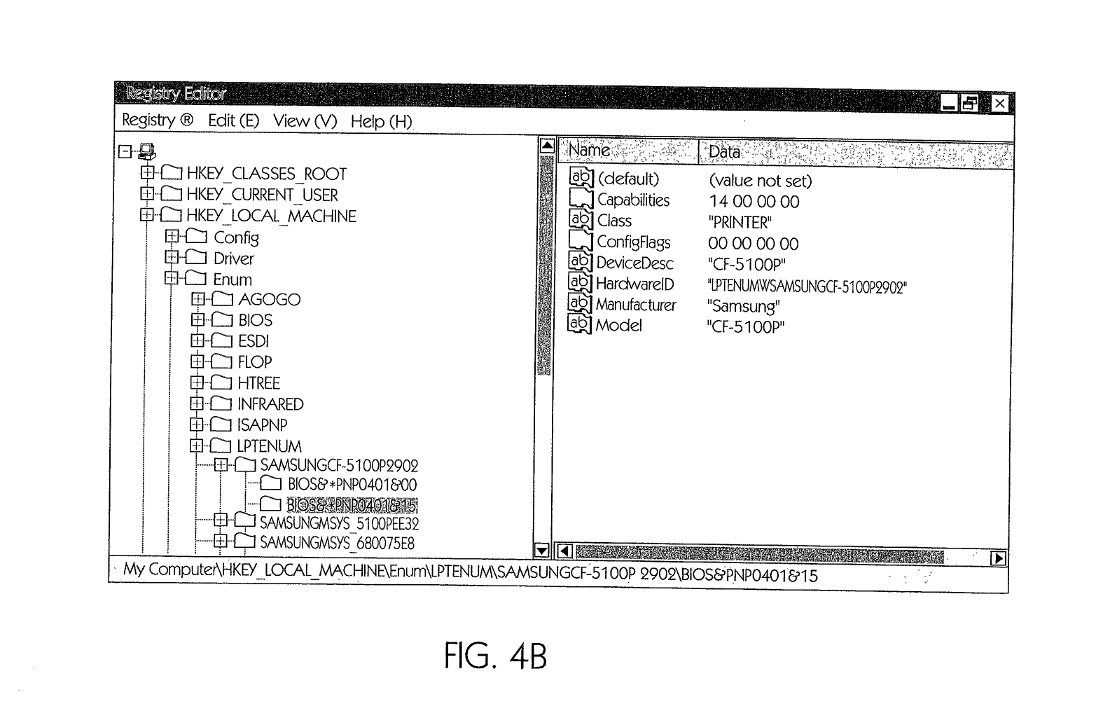

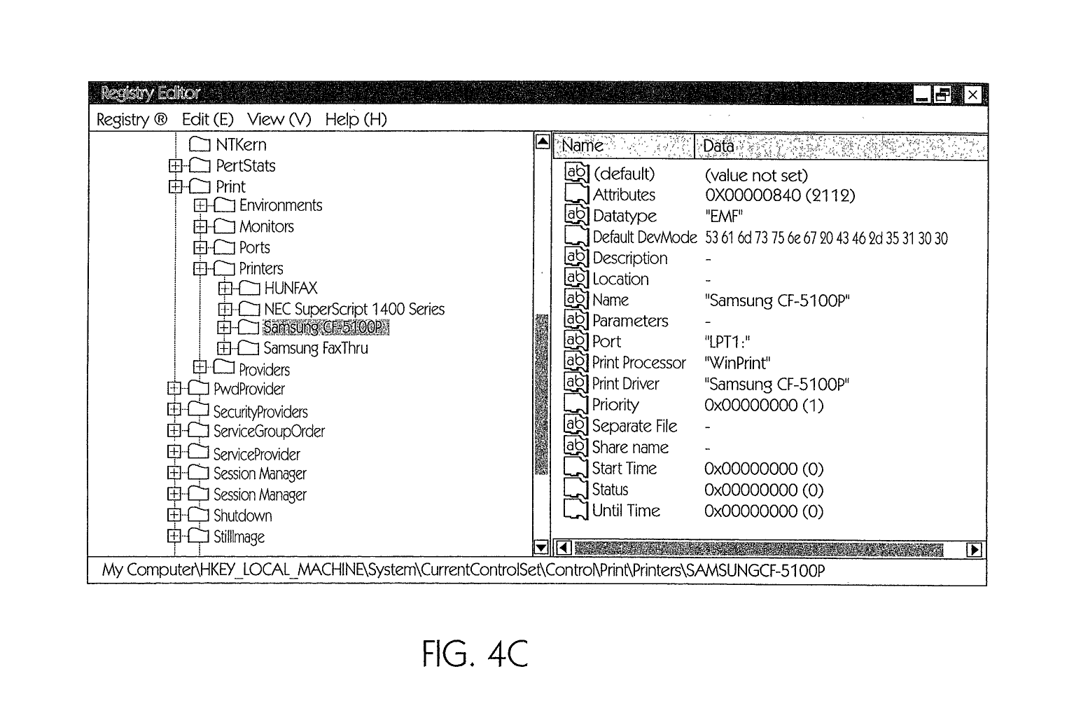

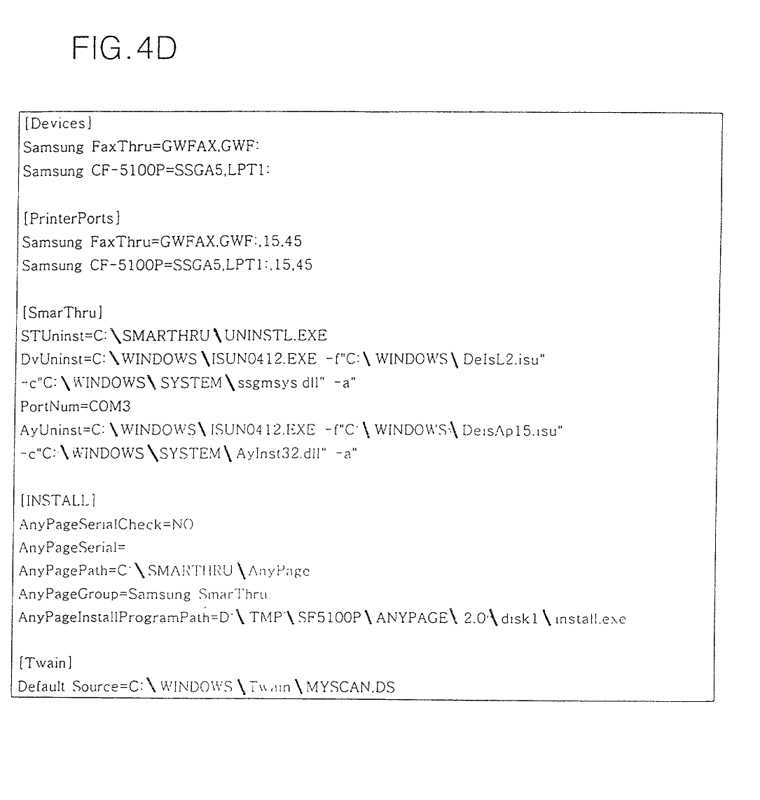

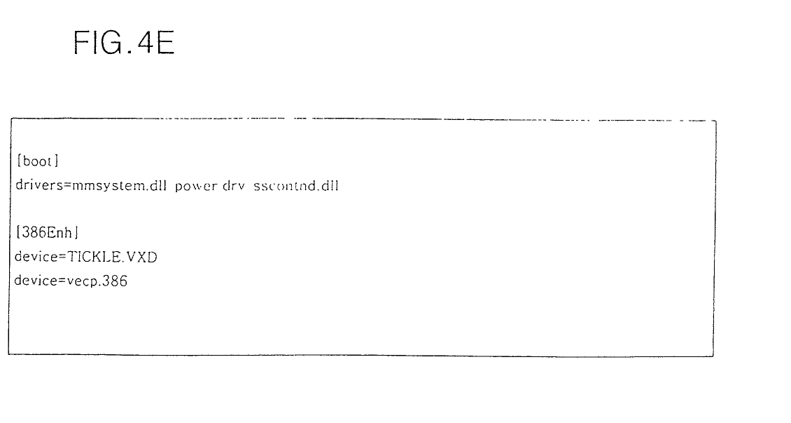

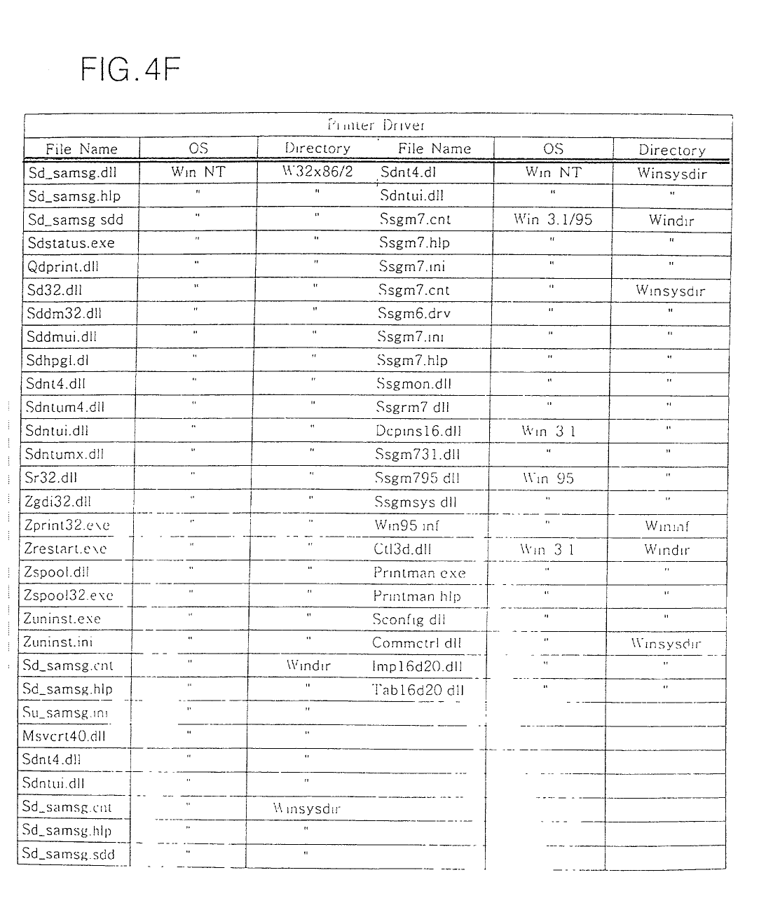

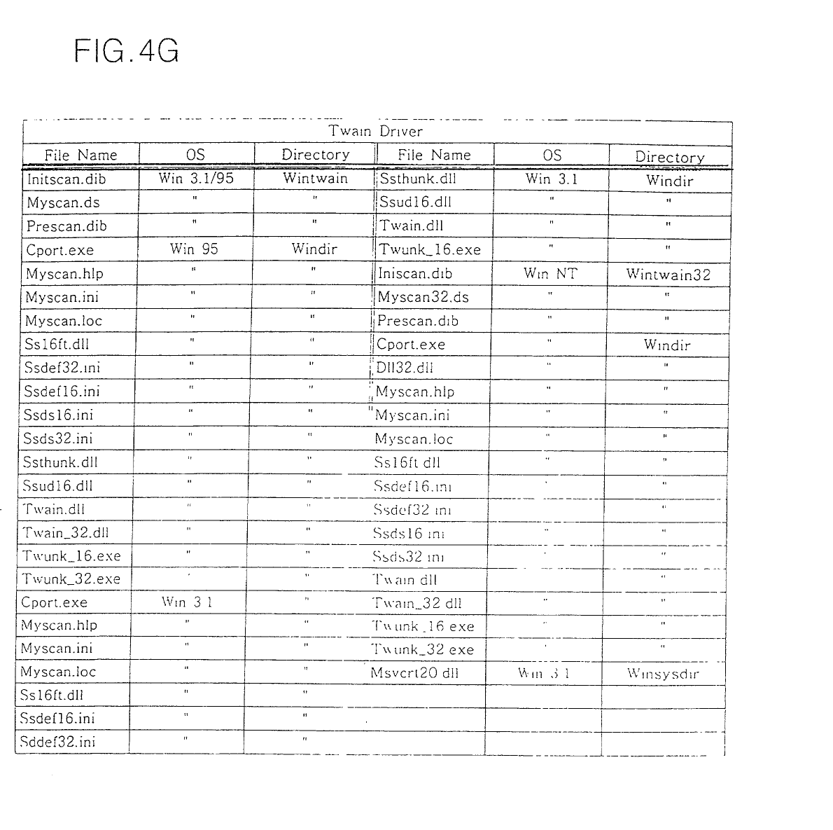

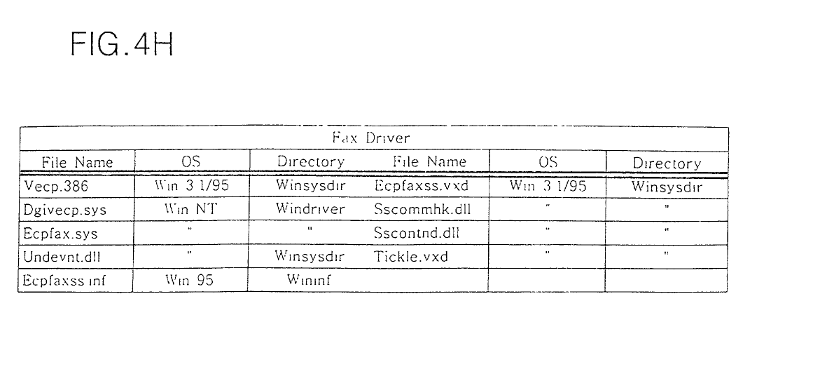

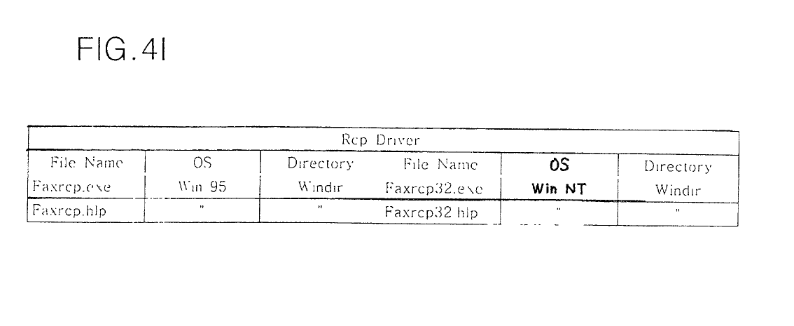

FIGS. 4A to 4I show a process of installing various device drivers in the user computer. Through the process of installing the device driver, a location of the device driver information used to detect the device driver error is understood. FIG. 4A shows an initial screen of the device driver installation program. FIGS. 4B and 4C show an added registry and the set values of the added registry after completing installation of the device driver installation program. In other words, as shown in FIG. 4B, a location of the added registry “SAMSUNGCF-5100P2902\BIOS&*PNP0401&15” is “My Computer\HKEY_LOCAL_MACHINE\Enum\LPTENUM\SAMSUNGCF-5100P2902\BIOS&*PNP0401&15”, and the set value of the registry is shown on the right-hand side of the screen. Further, as shown in FIG. 4C, a location of the added registry “Samsung CF-5100P” is “My Computer\HKEY_LOCAL_MACHINE\system\CurrentControlSet\Control\print\Printers\Samsung CF-5100P”, and the set values of the added registry are shown on the right hand side of the screen.

FIGS. 4D and 4E show changed system files after completing the installation of the device driver installation program. FIG. 4D shows a content of a file “WIN.INI”, and FIG. 4E shows a content of a file “STSTEM.INI”. Win.ini and system.ini are system initialization files used in the WINDOWS operating system.

FIG. 4F shows a directory where printer driver files copied are located in various operating systems (OS) after completing the installation of the device driver installation program. FIG. 4G shows a directory where copied scanner driver files (twain drivers) are located in various operating systems (OS) after completing the installation of the device driver installation program. FIG. 4H shows a directory where copied facsimile driver files are located in various operating systems (OS) after completing the installation of the device driver installation program. FIG. 4I shows a directory where state display monitor driver files copied are located in various operating systems (OS) after completing the installation of the device driver installation program

In FIGS. 4F through 4I, “Windir” represents a directory “Windows”. “Winsysdir” represents a directory “Windows\System.” “W32×86/2” represents a directory “Windows\System\spool\drivers\w32×86”. “Wininf” represents a directory “Windows\inf”. “Windriver” represents a directory “Windows\System\drivers”. “Wintwain 32” represents a directory “Windows\twain_{—}32”. “Wintwain” represents a directory “Windows\twain”.

As described above, since the files and system information required for the diagnosis of the device driver are located on a predetermined location as shown in FIG. 6, the monitoring file can diagnose the device driver using the file and system information, whereupon driver error handling program can correct the device driver errors automatically.

As described herein before, using the system for real-time device driver error handling, even those who are not skilled in device drivers can correct device driver errors accurately. Further, device driver error correction is simple as compared with the conventional method. Furthermore, it is easy to maintain the device, leading to a high reliability of the product.

While the invention has been particularly shown and described with reference to first preferred embodiments thereof, it will be understood by those skilled in the art that the foregoing and other changes in form and details may be made therein without departing from the spirit and scope of the invention.

What is claimed is:

1. A system for real-time device driver error handling, comprising:
a computer comprising a device driver, a monitoring unit and a device driver information, said monitoring unit monitoring an operating state and searching said device driver information, and outputting said diagnosing message to said computer when said device driver errors occur; and
a web server comprising a driver error handling program, said device driver error handling program storing a standard driver information, performing a diagnosis of said device driver by comparing said standard driver information with said device driver information, and displaying said diagnosing result on said computer.

2. The system of claim 1, with said web server further comprising:
a first portion storing said standard driver information;
a second portion interpreting said device driver information searched by said monitoring unit;
a third portion performing a diagnosis of said device driver by comparing said standard driver information from said first portion with said device driver information from said second portion; and
a fourth portion displaying the diagnosing result from said third portion to said computer.

3. The system of claim 2, with said fourth portion displaying the error correction result to said computer after automatically correcting the error by said standard diagnosis information stored in said first portion in case of an automatically correctable error, said fourth portion displaying how to correct the error to said computer in case of automatically uncorrectable error when the device driver error occurs.

4. The system of claim 1, with said monitoring unit being a file of said computer, said file being a logical block of computer information as designated by a name and treated as a unit.

5. The system of claim 4, with said file not being able to be manipulated by a user of said computer.

6. The system of claim 2, with said standard driver information being changeable by an operator of said web server.

7. The system of claim 3, with the automatically uncorrectable error being a hardware error of said computer or a device corresponding to said device driver.

8. A method of real-time device driver error handling, comprising:
installing a monitoring unit in order to monitor a state of a computer and an operating state of a device driver in said computer;
storing a standard diagnosis information of said device driver in order to perform a diagnosis of said device driver;
monitoring an operating state of said device driver to detect device driver errors through said monitoring unit;
contacting said computer with a web server to execute a driver error handling program through a network, said driver error handling program performing a diagnosis of said device driver;
confirming the device driver errors by comparing standard driver information with said device driver information of said device driver; and
displaying a diagnosing result to said computer from said step of confirming the device driver errors.

9. The method of claim 8, further comprising,
discriminating whether the device driver error is an automatically correctable error or an automatically uncorrectable error;
correcting the device driver error when said computer accepts a correction message in case of the automatically correctable error, thereafter displaying an error correction result; and
displaying how to correct the device driver errors in case of the automatically uncorrectable error.

10. The method of claim 8, further comprising
outputting a message of an automatic correction advice to said computer when said computer does not accept said correction message in case of the automatically correctable error.

11. The method of claim 8, with said step of installing said monitoring unit being to simultaneously install said monitoring unit for said device driver when said device driver is installed in said computer.

12. The method of claim 8, with said web server further comprising:
a first portion storing said standard diagnosis information of said device driver;
a second portion interpreting said device driver information searched by said monitoring unit
a third portion performing a diagnosis of said device driver by comparing said standard diagnosis information with said device driver information; and
a fourth portion displaying the diagnosing result to said computer.

13. The method of claim 8, with said monitoring unit being a file of said computer, said file being a logical block of computer information a s designated by a name and treated as a unit.

14. The method of claim 13, with said file not being able to be manipulated by a user of said computer.

15. The method of claim 8, with said standard diagnosis information being changeable by an operator of said web server.

16. The method of claim 9, with the automatically uncorrectable error being a hardware error of said computer or a device corresponding to said device driver.

17. A method, comprising the steps of:
monitoring an operational state of a device driver installed on a first computer;
storing standard diagnosis information of said device driver on a second computer, said standard diagnosis information being when an operational state of said device driver is normal;
networking said first computer with said second computer;
outputting said monitored device driver information from said monitoring of the operational state of said device driver;
sending said monitored device driver information from said first computer to said second computer;
comparing said standard diagnosis information with said monitored device driver information to confirm any error with said device driver;
displaying instruction for correcting the error of said device driver when the error is not automatically correctable; and
correcting the error of said device driver when the error is automatically correctable.

18. The method of claim 17, further comprising the steps of:
instructing by said first computer to said second computer to execute a program after said step of networking said first computer with said second computer, said program handling the device driver error on said first computer;
searching for a monitoring file on said first computer by said program;
executing said monitoring file through instructions of said program; and
searching for said monitored device driver information by said monitoring file for said step of outputting said monitored device driver information.

19. The method of claim 18, further comprising the step of interpreting the monitored device driver information before said step of comparing said standard diagnosis information with said monitored device driver information.

20. The method of claim 19, further comprising the steps of:
displaying on said first computer a result of said step of comparing said standard diagnosis information with said monitored device driver information to confirm any error with said device driver;
discriminating whether the error is automatically correctable;
prompting a response from said first computer as to whether a correction is to be automatically executed when the error is automatically correctable; and
displaying on said first computer a result of the error correction after said step of automatically correcting the error.

21. The method of claim 20, with said second computer being a web server displaying a web page on said first computer for instruction by said first computer.

22. The method of claim 20, with the automatically correctable error being a software related error on said first computer and the automatically uncorrectable error being a hardware related error on said first computer.

23. The method of claim 20, further comprising the steps of:
recommending a correction of the error when the error is automatically correctable and when said first computer opted no correction in said step of prompting a response from said first computer;
executing no correction of the error when the recommendation is not accepted; and
correcting the error when the recommendation is accepted.
